(19) United States
(12) Patent Application Publication
(10) Pub. No.: US 2026/0091966 A1
(43) Pub. Date: Apr. 2, 2026

(54) LIFT ADAPTER ASSEMBLY

(71) Applicant: Robert Bosch GmbH, Stuttgart (DE)

(72) Inventor: Daniel Newkirk, Owatonna, MN (US)

(21) Appl. No.: 18/898,878

(22) Filed: Sep. 27, 2024

(51) Int. Cl. B66F 13/00; B66F 5/02; B66F 5/04

(52) U.S. Cl. CPC B66F 13/00; B66F 5/02; B66F 5/04

(57) ABSTRACT

A lift apparatus comprising a lift adapter suitable to engage and support a variety of vehicle components. The lift adapter comprises a number of support arms, each of the support arms being rotationally adjustable with respect to a support body of the lift adapter. A number of bracket assemblies mount interface adapters to the support arms, the interface adapters engaging and securing the vehicle component during an active lift service. The lift adapter may utilize a single type of interface adapter or a mixture of types of interface adapters to engage and secure a variety of vehicle components. The lift adapter may be detached from an associated lift to maximize flexibility in operation of the lift and lift adapter, while also maximizing compatibility with a variety of components.

### TECHNICAL FIELD

This disclosure relates to specialty tools for the service of automobiles. More specifically, this disclosure relates to lift tools for moving, removing, and hoisting heavy automotive vehicle components.

### BACKGROUND

During service of an automotive vehicle, parts and components of the vehicle may require removal or replacement. Some automotive components are large and heavy, necessitating the use of a lift to support the component during service for purposes of safety to the user and the component. Conventional lifts may have a flat support surface sufficient to provide support to a variety of components, but some components having irregular geometries or convex surfaces may not be secure and stable when supported by a conventional, flat lift support surface.

What is desired is a lift apparatus that is suitable to engage and securely support a wider variety of vehicle components having a wider variety of sizes and geometries. It is additionally desired for this lift apparatus to be compatible with existing conventional lifts.

### SUMMARY

One aspect of this disclosure is directed to a lift adapter comprising a base flange, a support body, a support arm, a bracket assembly, and an interface adapter. The base flange is suitable to couple to a support surface of a vehicle component lift. The support body is coupled to the base flange. The support arm extends from the support body. The bracket assembly detachably couples to the support arm. The bracket assembly comprises a fastener, and the fastener engages the interface adapter. The interface adapter interfaces with a vehicle component. The support arm is positionally adjustable relative to a swivel point of the support body. The support arm comprises a proximal end coupled to the support body and a distal end opposite from the proximal end, and the support body adjusts the rotational position of the support arm relative to the swivel point.

Another aspect of this disclosure is directed to a lift apparatus comprising a vehicle component lift and a lift adapter. The vehicle component lift has a support surface. The lift adapter has a base flange, a support body, a support arm, a bracket assembly, and an interface adapter. The base flange is coupled to the support surface. The support body is coupled to the base flange. The support arm extends from the support body. The bracket assembly detachably couples to the support arm. The bracket assembly comprises a fastener, and the fastener engages the interface adapter. The interface adapter interfaces with a vehicle component. The support arm is positionally adjustable relative to a swivel point of the support body. The support arm comprises a proximal end coupled to the support body and a distal end opposite from the proximal end, and the support body adjusts the rotational position of the support arm relative to the swivel point.

A further aspect of this disclosure is directed to a lift apparatus comprising a vehicle component lift and a lift adapter. The vehicle component lift has a support surface. The lift adapter has a base flange, a support body, a plurality of support arms, a plurality of bracket assemblies, and a plurality of interface adapters. The base flange is coupled to the support surface. The support body is coupled to the base flange. Each of the support arms extend from the support body. Each bracket assembly detachably couples to one of the support arms. The bracket assemblies comprise a fastener, and the fasteners engage with one of the interface adapters. Each interface adapter interfaces with a vehicle component. The support arms are positionally adjustable relative to a swivel point of the support body. Each support arm comprises a proximal end coupled to the support body and a distal end opposite from the proximal end, and the support body adjusts the rotational position of the support arm relative to the swivel point. The embodiment may comprise a plurality of four support arms, four bracket assemblies, and four interface adapters. In some embodiments, the plurality of interface adapters may comprise the same type of interface adapter, or mixed types of interface adapters.

The above aspects of this disclosure and other aspects will be explained in greater detail below with reference to the attached drawings.

### BRIEF DESCRIPTION OF THE DRAWINGS

FIG. 1 is an illustration of a lift apparatus including a vehicle component lift and a lift adapter.

FIG. 2 is an illustration of the lift apparatus of FIG. 1 in an alternative configuration.

FIG. 3 is an illustration of a lift adapter.

FIG. 4 is a close-up illustration showing additional features of the lift adapter of FIG. 3.

FIG. 5 is a close-up illustration showing additional features of the lift adapter of FIG. 3.

FIG. 6 is an illustration of different types of interface adapters for use with a lift adapter.

FIG. 7 is a detailed view an extensible bridge type of interface adapter.

FIG. 8 is a detailed view of a tab adapter type of interface adapter.

FIG. 9 is a detailed view of cone adapter type of interface adapter.

FIG. 10 is a detailed view of a foam block adapter type of interface adapter.

FIG. 11 is an illustration of a lift apparatus including a lift adapter supporting an electric drive for an electric vehicle.

FIG. 12 is an illustration of a lift apparatus including a lift adapter supporting a vehicle subframe.

FIG. 13 is a close-up illustration of the lift adapter supporting the vehicle subframe of FIG. 12, showing additional features.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

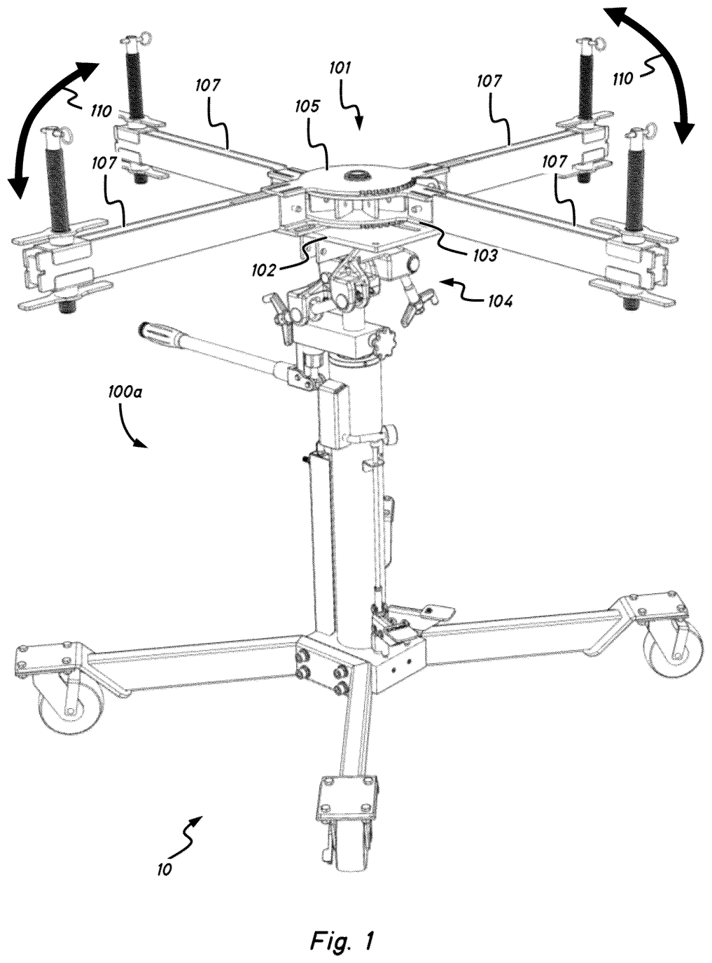

FIG. 1 is an illustration of a lift apparatus 10 comprising a vehicle component (VC) lift 100 and a lift adapter 101. In the depicted embodiment, the VC lift 100 is a VC lift 100a having a first configuration with a support surface 102 and a multi-axis positioner 104, but other embodiments may comprise different configurations without deviating from the teachings disclosed herein. Other embodiments for VC lift 100 will be described later in this disclosure without deviating from the teachings disclosed herein. In the depicted embodiment, multi-axis positioner 104 is configured to adjust the relative orientation of support surface 102 in three rotational dimensions, in addition to the three linear dimensions achieved via the placement of VC lift 100 along the ground surface (e.g., the natural ground, the floor of a work space, etc.) and a vertical height adjustment of the VC lift 100.

The lift adapter 101 comprises a base flange 103 that couples to support surface 102. Base flange 103 is coupled to a support body 105 of lift adapter 101. Extending from support body 105 are a plurality of support arms 107. In the depicted embodiment, lift adapter 101 comprises a plurality of four support arms 107, but other embodiments may comprise a single support arm or a different plurality without deviating from the teachings disclosed herein.

Lift adapter 101 is configurable to adjust the rotational position of one or more of support arms 107 along a rotational direction 110. In the depicted embodiment, support arms 107 are shown in an “open” position, suitable to receive loads of large surface area.

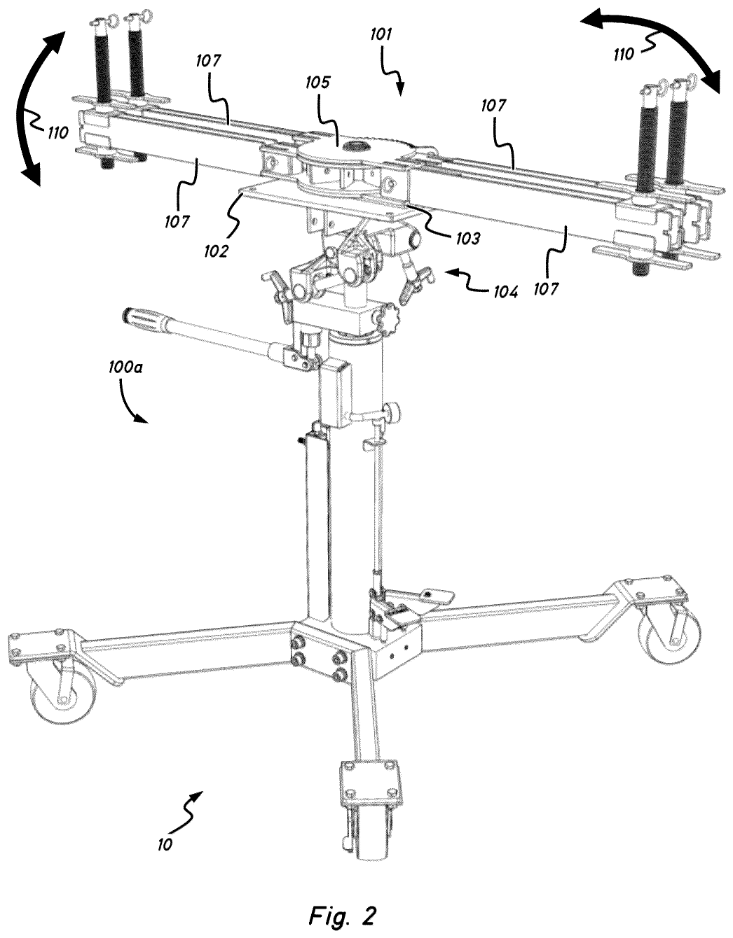

FIG. 2 shows the lift apparatus 10 with the support arms 107 in a “closed” position, suitable for narrower loads, or for compact storage of lift adapter 101. In the depicted embodiment, lift adapter 101 is detachably coupled to support surface 102, and may be secured using a retaining mechanism such as one or more bolts, pins, or other retaining mechanisms known to one of ordinary skill in the art at the time the invention was made. Advantageously, detachably coupling lift adapter 101 with VC lift 100 permits a user of the lift apparatus 10 to utilize the VC lift 100 for suitably stable loads during vehicle surface (e.g., supporting or removing components with large, flat, stable surfaces), while lift adapter 101 can be coupled to provide compatibility with unstable or irregular vehicle components.

Support arms 107 can be adjusted into a range of rotational angles with respect to support body 105 and the other support arms 107. Advantageously, this range of rotational angles maximizes compatibility of the lift adapter 101 with a wide variety of vehicle components during service.

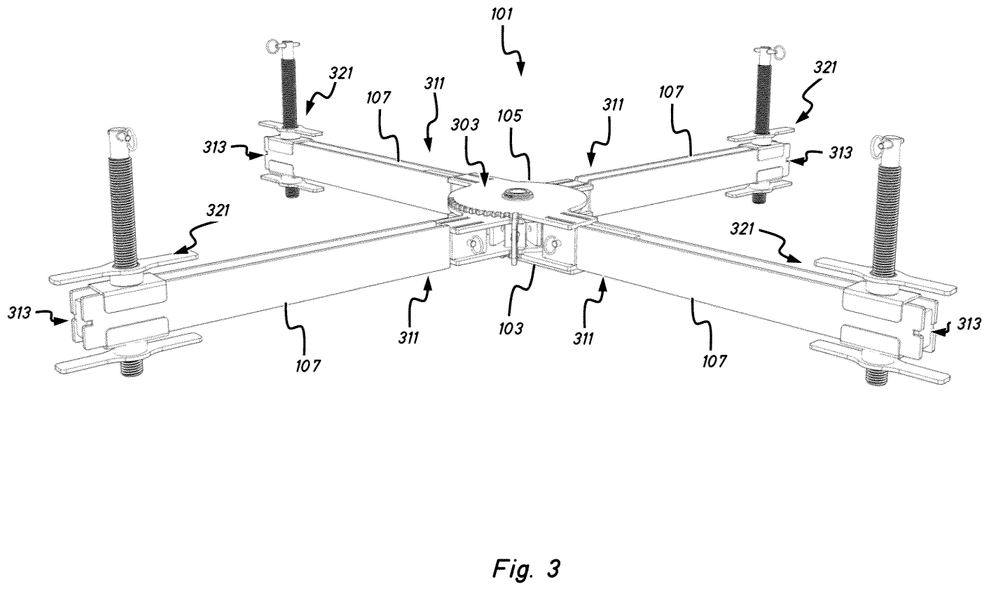

Additional features of lift adapter 101 are illustrated in FIG. 3. Support body 105 of lift adapter 101 additionally comprises a top flange 303 that remains in alignment with base flange 103. The relative rotational position of each of support arms 107 (along a rotational direction such as rotation direction 110; see FIG. 1) may be adjusted by adjusting the configuration of the top flange 303 relative to the base flange 103. Each of support arms 307 comprises a proximal end 311 near to support body 105 and a distal end 313 located opposite the length of the respective support arm 107 from its proximal end 311. Each proximal end 313 is coupled to support body 105, while each distal end 313 is freely positionable, creating a rotational motion of support arm 105 with respect to a swivel point of support body 105. In the depicted embodiment, the swivel point is the center point of top flange 303, but other embodiments may comprise other configurations, including other configurations having multiple swivel points corresponding to different support arms 107, without deviating from the teachings disclosed herein.

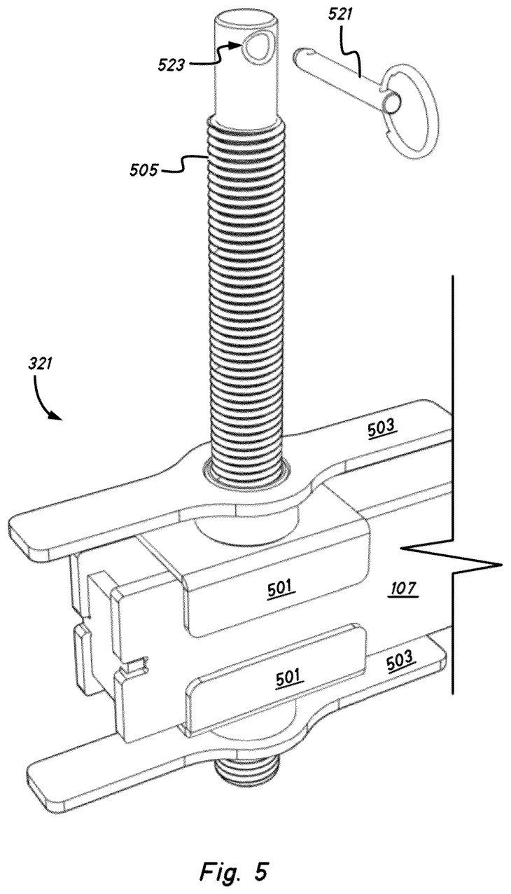

Each of support arms 107 is associated with a bracket assembly 307. Each bracket assembly 307 is configured to couple additional adapter components to lift adapter 101 to advantageously maximize the compatibility of lift adapter 101 with a maximal variety of vehicle components. Additional features of bracket assemblies 307 are discussed later with respect to FIG. 5.

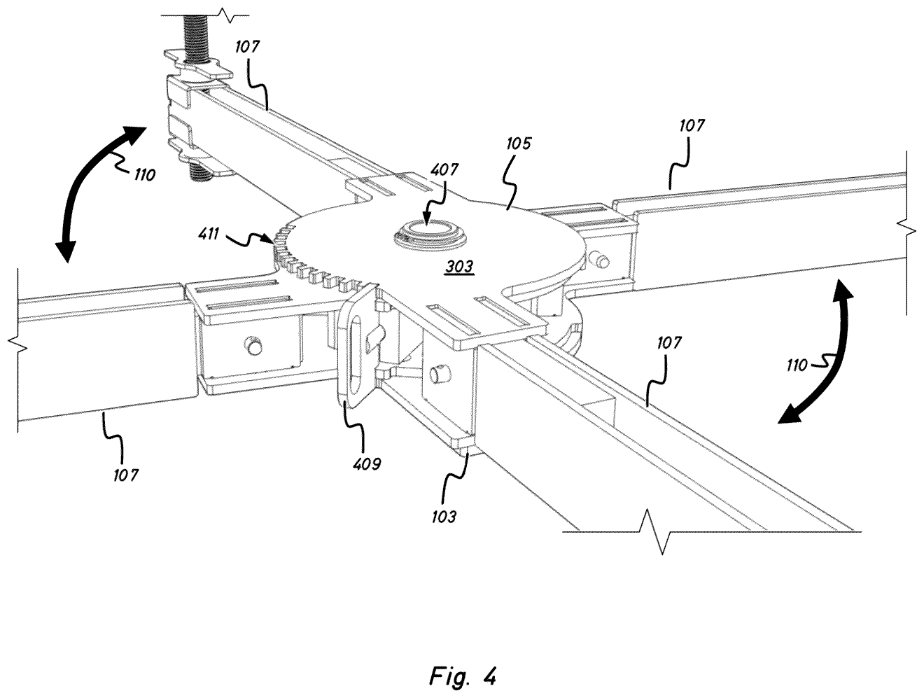

FIG. 4 is a closeup illustration of support body 105, showing additional features related to the rotational positionability of support arms 107. In the depicted embodiment, the swivel point 407 is more clearly visible, with each of the support arms 107 arranged in an outward extension from swivel point 407, with the full length of support arms moving in rotational direction 110.

A desired rotational position of support arms 107 may be locked into place utilizing a retaining mechanism. In the depicted embodiment, the retaining mechanism comprises lock insert 409 that engages with the support body 105 to prevent any additional rotational motion about the swivel point 407. Lock insert 409 is removable by a user in order to regain rotational motion at any time, but engages one of a set of retention teeth 411 when inserted. In the depicted embodiment, support body 105 comprises a set of retention teeth 411 sufficiently provide a full range of motion between the support arms 107, with the support arms forming a parallel configuration (see, e.g., FIG. 2) between the other support arms 107 all the way up to a right angle configuration, as illustrated here in FIG. 4. In the depicted embodiment, the retention teeth 411 are disposed upon the top flange 303, but other embodiments may comprise a different placement, a different number of retention teeth, or a different configuration for a retaining mechanism without deviating from the teachings disclosed herein. Some embodiments may not comprise a retaining mechanism without deviating from the teachings disclosed herein.

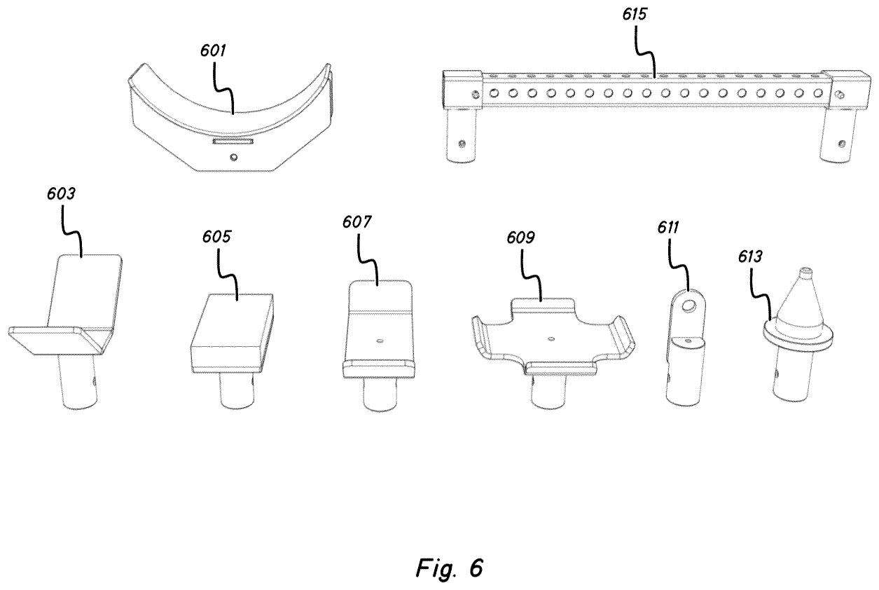

FIG. 5 is a close-up illustration of a bracket assembly 321 detachably coupled to a support arm 107. Bracket assembly 321 comprises a plurality of clamps 501, a plurality of bracket retainers 503, and a fastener 505. Clamps 501 engage with support arm 107, permitting placement of the bracket assembly 321 at a particular position relative to the length of support arm 107. The relative position of bracket assembly 321 is locked by the bracket retainers 503. In the depicted embodiment, bracket retainers 503 comprise threaded nuts suitable to engage with fastener 505, creating compressive force to hold clamps 501 in place, but other embodiments may comprise other configurations without deviating from the teachings disclosed herein. In this embodiment, fastener 505 comprises a threaded bolt, which advantageously provides threads to engage with bracket retainers 503 and additionally may engage additional interface adapters (see FIG. 6). Other embodiments may comprise other fastener types without deviating from the teachings disclosed herein.

Fastener 505 engages with interface adapters, which will be utilized to directly engage with components for which a lift (such as lift 100; see FIG. 1) supports during automotive service. The interface adapters may engage fastener 505 via the threads in the depicted embodiment, or may be coupled and locked into a detachable coupling by a lock pin 521. In the depicted embodiment, fastener 505 additionally comprises a lock channel 523 to receive lock pin 521 when used to retain coupling with an interface adapter.

FIG. 6 provides an illustration of a number of differently configured interface adapters for engaging different types of vehicle components. The depicted interface adapter types include a curve saddle 601, V-saddle 603, foam block adapter 605, U-saddle 607, 4-tab cradle 609, tab adapter 611, cone adapter 613, and extensible bridge 615. Other embodiments may comprise other interface adapter types without deviating from the teachings disclosed herein.

The curve saddle 601, V-saddle 603, U-saddle 607, and 4-tab cradle 609 primarily engage with an vehicle component by providing a surface for the component to rest, and providing additional geometry to provide simple geometry for additional security of the engagement. Additionally, 4-tab cradle 609 comprises four tabs that may be inserted into slots or other crevices of a vehicle component that are suitable to receive one or more of the four tabs of 4-tab cradle 609. Additional features of the other interface adapter types are discussed in greater detail below.

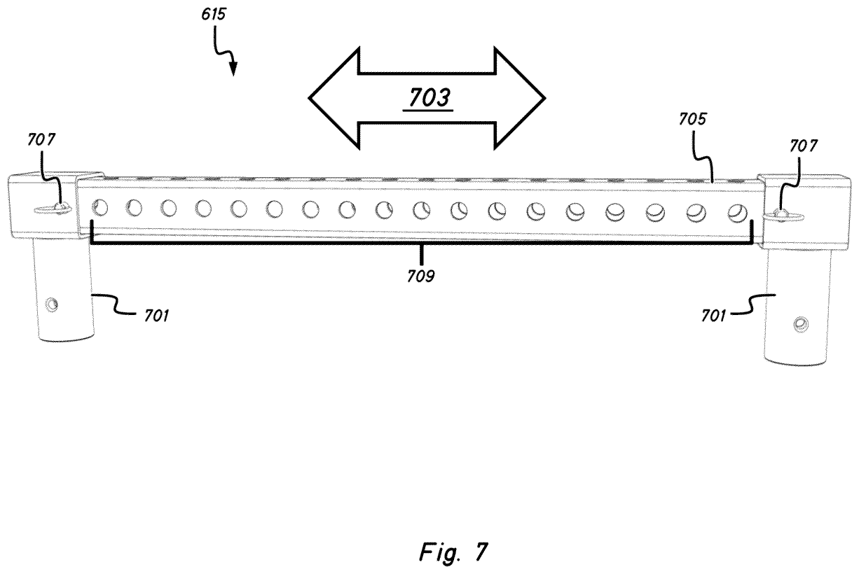

FIG. 7 is an illustration of extensible bridge 615. Extensible bridge 615 is unique amongst the depicted interface adapters because it has two mounts 701, and thus is most stable when it engages with two separate retainers 505 (see FIG. 5) disposed upon two different support arms 107 (see FIG. 1, FIG. 2, FIG. 3). In order to accommodate the variety of placements of the support arms 107, extensible bridge is extensible and contractable in a direction 703 along it's length between its mounts 701. In the depicted embodiment, this extensibility is accomplished using a sliding mechanism of the body 705 of extensible bridge 615, and the length can be retained and locked securely using extension pins 707. Extensible bridge 709 additionally comprises a linear series of pin holes 709 suitable to receive extension pins 707 and secure the desired length for extensible bridge 615 during use. Extension pins 707 may be removed from their associated pin hole 709 at any time the extensible bridge 615 is not under load, permitting re-adjustment of the length along direction 703 for a new configuration of lift adapter 101 (see, e.g., FIG. 1).

Extensible bridge 615 is additionally unique amongst the interface adapters depicted because pin holes 709 are sufficient to receive and secure additional interface adapters, advantageously providing a maximal degree of flexibility in the choice and operation of lift adapter 101 with a wide variety of vehicle components.

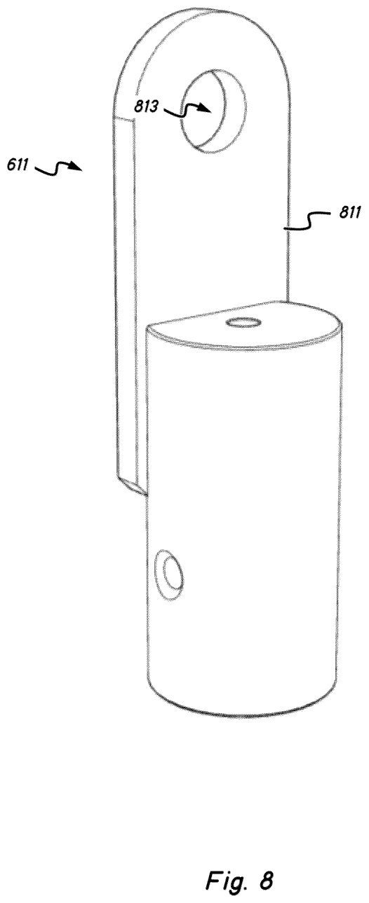

FIG. 8 is an illustration of tab adapter 611. Tab adapter 611 is unique amongst the interface adapters depicted because not only does it comprise a tab 811 suitable for insertion into slots and crevices of components of appropriate dimensions, tab adapter 611 further comprises an aperture 813 that is configured to receive additional fasteners, such as pins, bolts, screws, or other fasteners used with vehicle components. Such additional fasteners can provide maximally secure engagement of tab adapter 611 with compatible vehicle components.

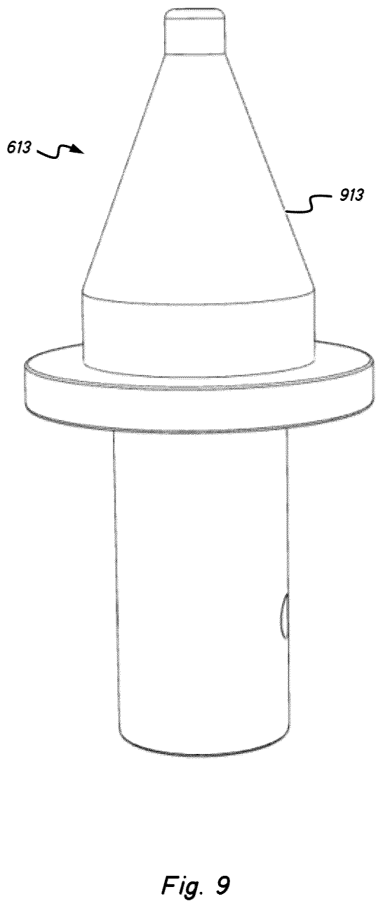

FIG. 9 is an illustration of cone adapter 613. Cone adapter 913 comprises a cone extension 913 that can provides a stable engagement with circular ports of a wide variety of sizes. Because of the conical shape of cone extension 913, vehicle components having a variety of mounting points with circular recesses can be safely and securely engaged advantageously with a single adapter type.

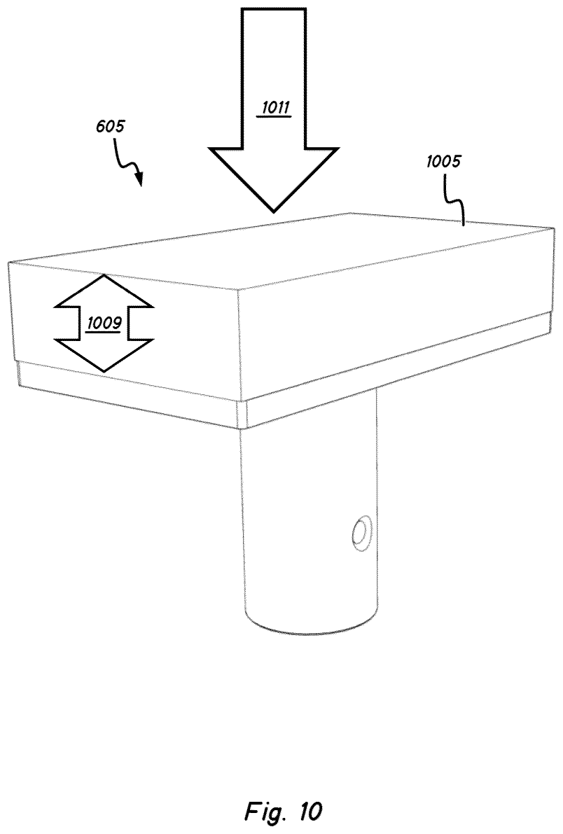

FIG. 10 is an illustration of foam block adapter 605. Foam block adapter 605 is unique amongst the interface adapters because it comprises a foam extension 1005 an elastomer material that elastically deforms in a direction 1009 when subject to a load in a direction 1011, such as when receiving the load of a vehicle component. Foam extension 1005 additionally provides a soft material to cradle vehicle components, which is advantageous for providing a surface that will not scratch, mar, or damage delicate surface materials (such as ceramics or plastics) and will not scratch or otherwise mar surfaces of materials that have a cosmetic or aesthetic component (e.g., windshield glass, shiny chrome components, etc.). When not under load, the foam extension 1005 returns to its initial shape and dimensions with elastic resilience. In the depicted embodiment, foam extension 1005 comprises a rectangular prism, but other embodiments may comprise any suitable shape or dimensions for foam block adapter 605 without deviating from the teachings disclosed herein. In some such embodiments, foam extension 1005 may comprise a concave geometry, convex geometry, conical geometry, cylindrical geometry, circular geometry, pyramid geometry, triangular geometry, regular polygonal geometry, regular polyhedral geometry, irregular polygonal geometry, or irregular polyhedral geometry without deviating from the teachings disclosed herein.

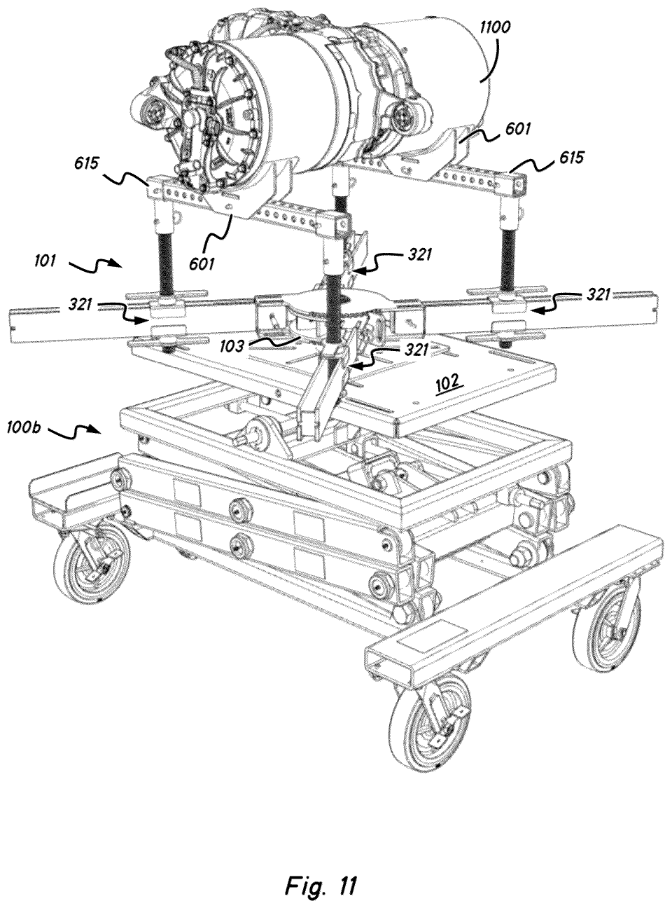

FIG. 11 is an illustration of a lift apparatus comprised of a VC lift 100 and lift adapter 101 to support a vehicle component in the form of an electric drive 1100. In this depicted embodiment, VC lift 100 comprises a heavy-duty lattice lift, but other embodiments may comprise other configurations without deviating from the teachings disclosed herein, provided that the VC lift 100 comprises a support surface 102 suitable to engage with base flange 103 of lift adapter 101.

This depiction notably illustrates how multiple adapter interfaces can be utilized with other adapter interfaces. In the depicted embodiment, a pair of extensible bridges 615 engage with the bracket assemblies 321, while a second pair of interface adapters in the form of curve saddles 601 engage with the extensible bridges 615. In this embodiment, each extensible bridge 615 engages with one of the curve saddles 601, but other embodiments may comprise different configurations without deviating from the teachings disclosed herein.

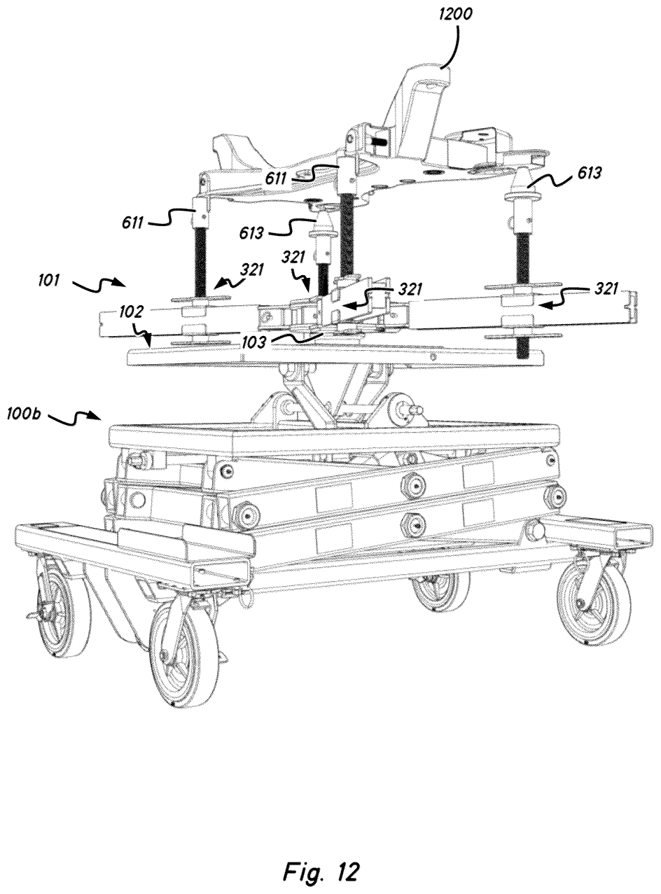

FIG. 12 is an illustration of a lift apparatus comprised of a VC lift 100 and lift adapter 101 to support a vehicle component in the form of a vehicle subframe 1200. In this depicted embodiment, VC lift 100 comprises a heavy-duty lattice lift, but other embodiments may comprise other configurations without deviating from the teachings disclosed herein, provided that the VC lift 100 comprises a support surface 102 suitable to engage with base flange 103 of lift adapter 101.

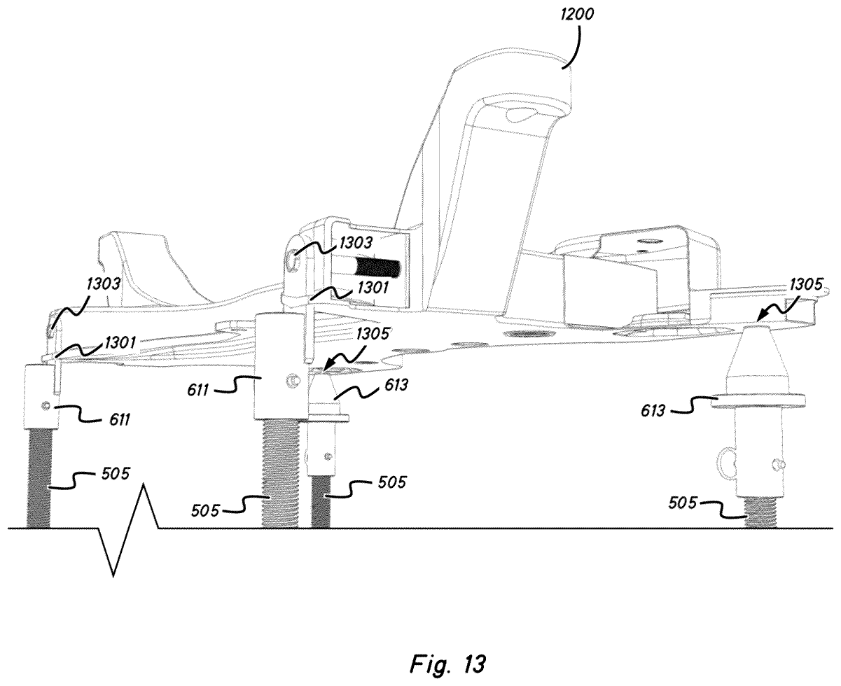

In this depiction, a variety of interface adapters are utilized, including tab adapters 611 and cone adapters 613. Additional detail of how the interface adapters engage and secure with vehicle subframe 1200 is scene in the close-up illustration of FIG. 13. In FIG. 13, it can be observed that each of tab adapters 611 are both inserted into a compatible slot 1301, but also additionally secured in their engagement using a compatible fastener 1303 compatible with both aperture 813 (not shown; see FIG. 8) and also a receptacle of vehicle subframe 1200. This advantageously provides a highly secure engagement during support of vehicle subframe 1200.

Additionally, it can be observed that each of cone adapters 613 engage with vehicle subframe 1200 but inserting into an existing mounting hole 1305 of the subframe geometry. This advantageously provides a secure support engagement while utilizing pre-existing geometry of the vehicle subframe 1200 during support thereof.

Additional configurations of a lift adapter 101 (see FIG. 1-4, FIG. 11-12) may be utilized with a different combination of interface adapters (see FIG. 6), a different number of interface adapters, or a different configuration of interface adapters without deviating from the teachings disclosed herein. The variety of interface adapter types and positionability of support arms 107 (see FIG. 1-4) advantageously maximizes the compatibility of lift adapter 101 with the broadest range of vehicle components to engage and support.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A lift adapter comprising:
a base flange;
a support body coupled to the base flange;
a support arm extending from the support body;
a bracket assembly detachably coupled to the support arm; and
an interface adapter that interfaces with a vehicle component,
wherein
the support arm comprises a proximal end coupled to the support body and a distal end opposite from the proximal end,
the support body adjusts the rotational position of the support arm relative to a swivel point of the support body, and
the bracket assembly comprises a fastener, the fastener engaging the interface adapter.

2. The lift adapter of claim 1, wherein the support body further comprises a retaining mechanism that retains the rotational position of the support arm relative to the swivel point when engaged.

3. The lift adapter of claim 1, wherein the support arm is a first support arm of a plurality of support arms, and wherein the bracket assembly is a first bracket assembly of a plurality of bracket assemblies.

4. The lift adapter of claim 3, wherein the support body further comprises a retaining mechanism that retains the rotational position of the support arm relative to the swivel point when engaged.

5. The lift adapter of claim 3, wherein the interface adapter comprises an extensible bridge, the extensible bridge spanning between the fasteners of two bracket assemblies, each of the two bracket assemblies detachably coupled to one of the support arms.

6. The lift adapter of claim 5, wherein the extensible bridge is a first interface adapter of a first configuration, and the extensible bridge detachably couples with a second interface adapter having a second configuration different from the first configuration.

7. The lift adapter of claim 6, wherein the second interface adapter comprises a V-saddle, a U-saddle, a 4-tab cradle, a curve saddle, a tab adapter, a cone adapter, or a foam block.

8. The lift adapter of claim 1, wherein the support arm is a first support arm of four support arms, each of the support arms comprising a proximal end and a distal end, wherein the support body adjusts the rotational positions of the support arms relative to a swivel point of the support body.

9. The lift adapter of claim 8, wherein the support body further comprises a retaining mechanism that retains the rotational position of the support arms relative to the swivel point when engaged.

10. The lift adapter of claim 8, wherein the interface adapter is a first interface adapter of a plurality of interface adapters, the plurality of interface adapters including a first interface adapter comprising a first extensible bridge spanning between two of the support arms, a second interface adapter comprising a second extensible bridge spanning between two of the support arms, a third interface adapter detachably coupled to the first extensible bridge and having a second configuration different from the first configuration, and a fourth interface adapter detachably coupled to the second extensible bridge and having a third configuration different from the first configuration.

11. The lift adapter of claim 10, wherein the third interface adapter comprises a V-saddle, a U-saddle, a 4-tab cradle, a curve saddle, a tab adapter, a cone adapter, or a foam block.

12. The lift adapter of claim 11, wherein the fourth interface adapter comprises a V-saddle, a U-saddle, a 4-tab cradle, a curve saddle, a tab adapter, a cone adapter, or a foam block.

13. The lift adapter of claim 1, wherein the interface adapter comprises an extensible bridge, a V-saddle, a U-saddle, a 4-tab cradle, a curve saddle, a tab adapter, a cone adapter, or a foam block.

14. The lift adapter of claim 13, wherein the interface adapter comprises a tab adapter, the tab adapter defining an aperture, the tab adapter receiving a fastener through the aperture to couple the tab adapter to the vehicle component.

15. The lift adapter of claim 13, wherein the interface adapter comprises a foam block that elastically deforms under a load of the vehicle component.

16. The lift adapter of claim 1, where the bracket assembly comprises a bracket retainer that retains the bracket assembly in position relative to the support arm when engaged.

17. The lift adapter of claim 16, wherein the bracket retainer engages with the threaded bolt.

18. A lift apparatus comprising:
a vehicle component lift having a support surface; and
a lift adapter having
a base flange coupled to the support surface;
a support body coupled to the base flange;
a support arm extending from the support body;
a bracket assembly detachably coupled to the support arm; and
an interface adapter that interfaces with a vehicle component,
wherein
the support arm comprises a proximal end coupled to the support body and a distal end opposite from the proximal end,
the support body adjusts the rotational position of the support arm relative to a swivel point of the support body, and
the bracket assembly comprises a fastener, the fastener engaging the interface adapter.

19. A lift apparatus comprising:
a vehicle component lift having a support surface; and
a lift adapter having
a base flange coupled to the support surface;
a support body coupled to the base flange;
a plurality of four support arms extending from the support body;
a plurality of four bracket assemblies, each bracket assembly detachably coupled to one of the support arms; and
a plurality of interface adapters that each interface with a vehicle component,
wherein
each of the support arms comprise a proximal end coupled to the support body and a distal end opposite from the proximal end,
the support body adjusts the rotational position of each of the support arms relative to a swivel point of the support body, and
each bracket assembly comprises a fastener, each fastener engaging with one of the interface adapters.

20. The lift apparatus of claim 19, wherein each of the interface adapters comprises an extensible bridge, a V-saddle, a U-saddle, a 4-tab cradle, a curve saddle, a tab adapter, a cone adapter, or a foam block.
